(19) United States
(12) Patent Application Publication
(10) Pub. No.: US 2026/0258745 A1
(43) Pub. Date: Sep. 3, 2026

(54) EXHAUST SYSTEM STATE DETERMINATION METHOD AND EXHAUST SYSTEM STATE DETERMINATION DEVICE

(71) Applicant: NISSAN MOTOR CO., LTD., Yokohama-shi, Kanagawa (JP)

(72) Inventors: Tohru SHIBATA, Kanagawa (JP); Mina HOSHINO, Kanagawa (JP)

(73) Assignee: NISSAN MOTOR CO., LTD., Yokohama-shi, Kanagawa (JP)

(21) Appl. No.: 18/994,447

(22) PCT Filed: Jul. 15, 2022
(86) PCT No.: PCT/JP2022/027802

§ 371 Date: Jan. 14, 2025

(51) Int. Cl. F01N 11/00; B60W 20/16; G01K 3/00; G01N 15/08

(52) U.S. Cl. CPC F01N 11/002; B60W 20/16; G01K 3/005; G01N 15/0826; F01N 2550/04

(57) ABSTRACT

When an internal combustion engine mounted in a vehicle temporarily stops for a prescribed time or longer during an operation of the vehicle and the outside temperature is less than or equal to a prescribed temperature, it is determined that icing has occurred on one of a differential pressure sensor that detects a pressure loss of a gasoline particulate filter provided in an exhaust path of the internal combustion engine, an inlet-side pressure introduction pipe, and an outlet-side pressure introduction pipe, the pressure introduction pipes being paths for introducing a pressure into the differential pressure sensor. Thus, a failure of the differential pressure sensor to output an output signal of a correct value due to icing during the operation of the vehicle can be determined with high accuracy.

### TECHNICAL FIELD

The present invention relates to an exhaust system state determination method and an exhaust system state determination device.

### BACKGROUND ART

Patent Document 1 discloses a differential pressure sensor that measures a pressure loss at a gasoline particulate filter disposed in an exhaust pipe into which exhaust gas of an internal combustion engine is introduced.

Patent Document 1 determines whether at least one of an upstream pipe and a downstream pipe is in a frozen state, i.e., a state in which moisture inside the pipe(s) is frozen and may close the pipe(s), wherein the upstream pipe and the downstream pipe are structured to respectively transmit a pressure in an upstream side (i.e., an inlet side) and a pressure in a downstream side (i.e., an outlet side) of the gasoline particulate filter to the differential pressure sensor.

Patent Document 1 determines that at least one of the upstream pipe and the downstream pipe is in the frozen state, in case that an outside air temperature when an ignition switch is ON is lower than a predetermined first threshold, or in case that a water temperature when the ignition switch is ON is lower than a predetermined second threshold.

However, Patent Document 1 fails to consider a case of being frozen again after resolution of the frozen state during vehicle driving.

According to Patent Document 1, it is difficult to determine the frozen state again after the frozen state is once determined and then resolved. Patent Document 1fails to suppose the case of being frozen again after resolution of the frozen state, and has a room for improvement in precise determination of the frozen state.

### PRIOR ART DOCUMENT(S)

### Patent Document(s)

Patent Document 1: JP 2020-143595 A

### SUMMARY OF THE INVENTION

According to an aspect of the present invention, an exhaust system state determination method for an exhaust system of an internal combustion engine mounted in a vehicle, wherein the exhaust system includes a differential pressure sensor structured to measure a pressure loss at an exhaust particulate filter disposed in an exhaust passage of the internal combustion engine, includes determining that freezing in one of the differential pressure sensor and a path structured to introduce pressure into the differential pressure sensor is present, in response to satisfaction of conditions that: the internal combustion engine has been temporarily stopped for a predetermined time period or longer, during driving of the vehicle; and an outside air temperature is equal to or lower than a predetermined temperature.

The above aspect of the present invention serves to precisely determine a case that the differential pressure sensor outputs an output signal having a wrong value due to freezing.

### BRIEF DESCRIPTION OF THE DRAWINGS

FIG. 1 is an illustrative view schematically showing an outline of an exhaust system to which the present invention is applied.

FIG. 2 is a timing chart showing how freezing determination is performed.

FIG. 3 is a flow chart showing a flow of the freezing determination.

### MODE(S) FOR CARRYING OUT THE INVENTION

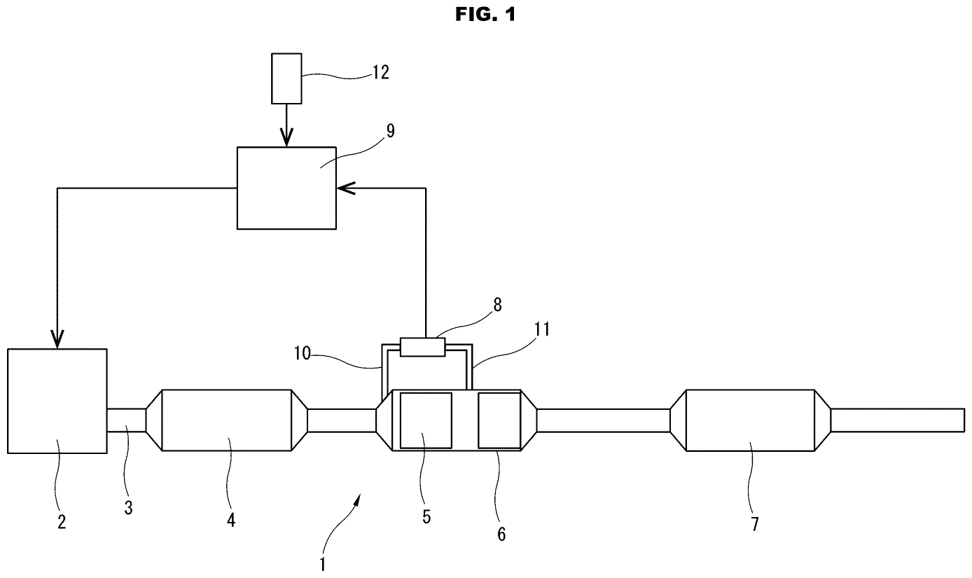

The following details an embodiment of the present invention with reference to the drawings. FIG. 1 is an illustrative view schematically showing an outline of an exhaust system 1 to which the present invention is applied.

Exhaust system 1 is mounted in a vehicle, and includes an internal combustion engine 2, an exhaust passage 3, a manifold catalyst 4, a Gasoline Particulate Filter (GPF) 5, an underfloor catalyst 6, a muffler 7, a differential pressure sensor 8, and a control unit 9. Differential pressure sensor 8 is structured to measure a pressure loss at GPF 5. Control unit 9 is configured to perform a freezing diagnosis described below.

Internal combustion engine 2 is a spark ignition type internal combustion engine fueled by gasoline and mounted in the vehicle such as an automobile.

Specifically, the vehicle including internal combustion engine 2 is an idle stop vehicle structured to perform idle stopping by an idle stop control or a hybrid vehicle structured to perform EV travel that is self-propelled travel with internal combustion engine 2 stopped. In other words, the vehicle including internal combustion engine 2 is a vehicle allowed to temporarily stop internal combustion engine 2 during vehicle driving.

The idle stop control is configured, for example, to suspend fuel supply and automatically stop internal combustion engine 2 in response to satisfaction of a predetermined automatic stop condition, and resume the fuel supply and restart internal combustion engine 2 in response to satisfaction of a predetermined automatic restart condition during the automatic stopping.

The predetermined automatic stop condition is, for example, that a vehicle speed is lower than a predetermined value, an accelerator opening degree is less than a predetermined value, etc. The predetermined automatic restart condition is, for example, that the accelerator opening degree is greater than a predetermined value, a brake pedal is not depressed, etc.

The hybrid vehicle is structured to perform the EV travel that drives drive wheels with use of only a drive motor (not shown) as a drive source, and may be a so-called series hybrid vehicle structured not to use internal combustion engine 2 as a power source of the vehicle or a so-called parallel hybrid vehicle structured to use internal combustion engine 2 as a power source of the vehicle.

Manifold catalyst 4 is exemplarily a three-way catalyst, and is structured to purify exhaust gas. Manifold catalyst 4 is disposed relatively nearly to a combustion chamber (not shown) of internal combustion engine 2, e.g., disposed immediately downstream with respect to an aggregation part of an exhaust manifold.

GPF 5 and underfloor catalyst 6 are disposed under a floor of a living room of the vehicle, apart from the combustion chamber (not shown) of internal combustion engine 2. In other words, GPF 5 and underfloor catalyst 6 are disposed apart from an engine room of the vehicle.

GPF 5 corresponds to an exhaust particulate filter, and is structured to collect Particulate Matter (PM) contained in exhaust gas. GPF 5 is disposed downstream with respect to manifold catalyst 4.

Underfloor catalyst 6 is exemplarily a three-way catalyst, and is structured to purify exhaust gas. Underfloor catalyst 6 is disposed downstream with respect to GPF 5, adjacently to GPF 5.

Muffler 7 is structured to reduce exhaust noise, and is disposed downstream with respect to underfloor catalyst 6.

Differential pressure sensor 8 is structured to measure a pressure difference between an exhaust pressure at an inlet of GPF 5 and an exhaust pressure at an outlet of GPF 5. The exhaust pressure at the inlet of GPF 5 is introduced into differential pressure sensor 8 via an inlet pressure-introduction pipe 10. The exhaust pressure at the outlet of GPF 5 is introduced into differential pressure sensor 8 via an outlet pressure-introduction pipe 11. Inlet pressure-introduction pipe 10 and outlet pressure-introduction pipe 11 correspond to paths structured to introduce pressure into differential pressure sensor 8.

Control unit 9 is a known digital computer including a CPU, a ROM, a RAM, and an input/output interface. Control unit 9 receives measurement signals (i.e., output signals) from various sensors such as the differential pressure sensor 8, a crank angle sensor 12, and a sensor structured to measure an air-fuel ratio of internal combustion engine 2. Crank angle sensor 12 is structured to measure a crank angle of a crank shaft of internal combustion engine 2, and can measure an engine speed of internal combustion engine 2.

Control unit 9 is configured to calculate an amount of deposit of exhaust particles collected in GPF 5.

In detail, control unit 9 compares a first deposit amount calculated based on the output signal of differential pressure sensor 8 with a second deposit amount calculated based on operational status of internal combustion engine 2, and determines that the deposit amount of exhaust particulates is a larger one of the first deposit amount and the second deposit amount. The first deposit amount is a deposit amount calculated based on the pressure loss at GPF 5. The second deposit amount is a deposit amount calculated based on a physical model employing, for example, histories of the air fuel ratio, the engine speed, etc. of internal combustion engine 2.

Furthermore, control unit 9 is configured to control internal combustion engine 2 and implement various diagnoses.

Exhaust gas (i.e., burnt gas) flowing in exhaust passage 3 contains moisture. Thus, differential pressure sensor 8, inlet pressure-introduction pipe 10, and outlet pressure-introduction pipe 11 are in an environment containing moisture. Under an extremely low temperature such as an outside air temperature below the freezing point, differential pressure sensor 8 and inlet pressure-introduction pipe 10 and outlet pressure-introduction pipe 11, which are the paths structured to introduce pressure into differential pressure sensor 8, may be frozen. For example, in case that one of differential pressure sensor 8, inlet pressure-introduction pipe 10, and outlet pressure-introduction pipe 11 is frozen, the output signal of differential pressure sensor 8 fails to have a value representing the differential pressure at that moment, even without a failure in differential pressure sensor 8. This may cause a trouble in various controls and various diagnoses employing the output signal of differential pressure sensor 8. In other words, even without a failure in differential pressure sensor 8, the freezing in differential pressure sensor 8 and the paths for pressure introduction into differential pressure sensor 8 causes the output signal of differential pressure sensor 8 to deviate from a true value that should be originally outputted at that moment, and may cause a trouble in various controls and various diagnoses employing the output signal of differential pressure sensor 8.

If the freezing in differential pressure sensor 8 and the paths for pressure introduction into differential pressure sensor 8 can be precisely detected, various controls and various diagnoses employing the output signal of differential pressure sensor 8 are suppressed from undergoing a malfunction or a wrong diagnosis.

The various controls employing the output signal of differential pressure sensor 8 include, for example, a GPF 5 regeneration control performed based on the amount of deposit of exhaust particles in GPF 5. In case that the freezing causes an output signal of GPF 5 to deviate from a true value and causes the first deposit amount described above to be calculated as a value greater than it actually is, the GPF 5 regeneration control may fail to be appropriately performed. This may result in deterioration of GPF 5.

The various diagnoses employing the output signal of differential pressure sensor 8 include, for example, a failure diagnosis on differential pressure sensor 8 itself and a diagnosis on whether GPF 5 is installed in exhaust passage 3 or detached from exhaust passage 3. In case that the output signal of GPF 5 deviates from the true value due to the freezing, the failure diagnosis may wrongly determine GPF 5 to be out of order. Furthermore, in case that the output signal of GPF 5 deviates from the true value due to the freezing, the diagnosis may wrongly determine GPF 5 to be detached from exhaust passage 3, even if GPF 5 is actually installed in exhaust passage 3.

In view of the foregoing, the present invention discloses precisely determining the freezing in differential pressure sensor 8 and the paths for pressure introduction into differential pressure sensor 8, and suspending various controls and various diagnoses employing the output signal of differential pressure sensor 8, in response to abnormality in output of differential pressure sensor 8 due to the freezing, and thereby avoiding a malfunction and a wrong diagnosis.

The freezing determination is performed by control unit 9 serving as a determination section. Control unit 9 determines that the freezing in one of differential pressure sensor 8, inlet pressure-introduction pipe 10, and outlet pressure-introduction pipe 11 is present, in response to satisfaction of conditions that: internal combustion engine 2 has been temporarily stopped for a predetermined time period or longer, during vehicle driving; and the outside air temperature during the temporary stopping of internal combustion engine 2 is equal to or lower than a predetermine temperature. The predetermined temperature is exemplarily 0° C. In response to satisfaction of a condition that the freezing in one of differential pressure sensor 8, inlet pressure-introduction pipe 10, and outlet pressure-introduction pipe 11 is present, control unit 9 determines the output signal of differential pressure sensor 8 to deviate from the true value, and suspends various controls and various diagnoses employing the output signal of differential pressure sensor 8.

The outside air temperature may be estimated from, for example, a measurement signal of an air flow meter not shown. In another manner, the outside air temperature may be obtained from a temperature sensor separately disposed for measurement of the outside air temperature.

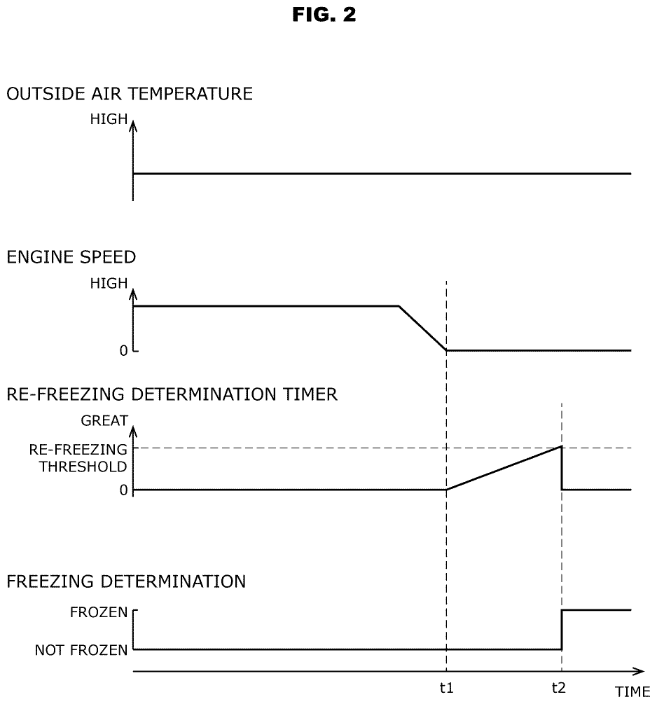

FIG. 2 is a timing chart showing how the freezing determination is implemented in case that the outside air temperature is constant at a temperature equal to or lower than the predetermined temperature. Time instant t1 is a timing at which internal combustion engine 2 during vehicle driving becomes zero in engine speed and stops. Furthermore, time instant t1 is a timing to start counting up (i.e., incrementing) a re-freezing counter of a re-freezing determination timer. Thus, the re-freezing counter of the re-freezing determination timer starts increasing at time instant t1. Time instant t2 is a timing at which a value of the re-freezing counter reaches a predetermined re-freezing threshold, and the freezing determination determines the freezing to be present. The re-freezing determination timer is configured to measure a duration time period of the temporary stopping of internal combustion engine 2. Substantially, the value of the re-freezing counter represents an elapsed time.

The re-freezing threshold may be changed depending on the outside air temperature. Specifically, the re-freezing threshold may be changed to decrease with decrease in outside air temperature. This means changing a time period from time instant t1 (at which internal combustion engine 2 stops) to time instant t2 (at which the value of the re-freezing counter reaches the predetermined re-freezing threshold) to be shorten with decrease in outside air temperature. Such change is allowed. The re-freezing determination timer is one of functions of control unit 9.

Exhaust system 1 according to the present embodiment serves to, during vehicle driving, precisely determine a case that the output signal of differential pressure sensor 8 has a wrong value due to the freezing.

Thus, the present invention serves to precisely determine whether at least one of differential pressure sensor 8 and the paths for pressure introduction into differential pressure sensor 8 is frozen.

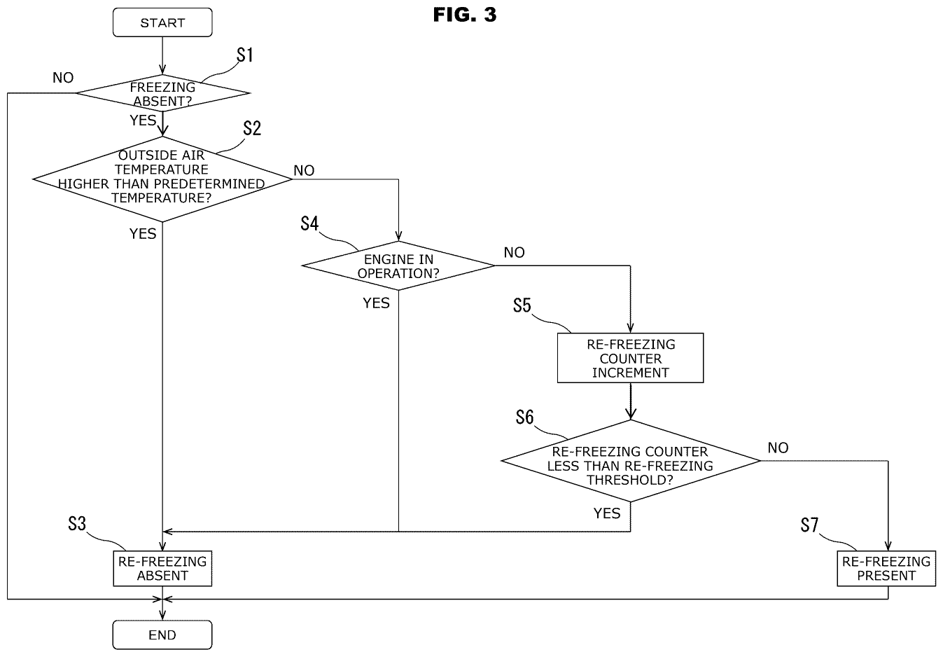

FIG. 3 is a flow chart showing a flow of the freezing determination in exhaust system 1 according to the above embodiment.

Step S1 determines whether the freezing in one of differential pressure sensor 8 and the paths for pressure introduction into differential pressure sensor 8 has been determined absent or present. If step S1 determines the freezing to be absent, step S2 is subsequently executed. If step S1 determines the freezing to be present, the routine this time is terminated. Incidentally, in case that the outside air temperature upon key-ON start of the vehicle is equal to or lower than the predetermined temperature, the freezing in one of differential pressure sensor 8 and the paths for pressure introduction into differential pressure sensor 8 is determined present.

Step S2 determines whether the outside air temperature is higher than the predetermined temperature or not. If step S2 determines the outside air temperature to be higher than the predetermined temperature, step S3 is subsequently executed. If step S2 determines the outside air temperature to be equal to or lower than the predetermined temperature, step S4 is subsequently executed.

Step S3 determines that re-freezing in differential pressure sensor 8 and the paths for pressure introduction into differential pressure sensor 8 is absent.

Step S4 determines whether internal combustion engine 2 is in operation (i.e., is rotating). If step S4 determines internal combustion engine 2 to be in operation, step S3 is subsequently executed. If step S4 determines internal combustion engine 2 to be stationary (i.e., be zero in engine speed), step S5 is subsequently executed.

Step S5 increments the re-freezing counter of the re-freezing determination timer.

Step S6 determines whether the re-freezing counter of the re-freezing determination timer is lower than the re-freezing threshold. If step S6 determines the re-freezing counter to be lower than the re-freezing threshold, step S3 is subsequently executed. If step S6 determines the re-freezing counter to have reached the re-freezing threshold, step S7 is subsequently executed.

Step S7 determines the re-freezing in one of differential pressure sensor 8 and the paths for pressure introduction into differential pressure sensor 8 to be present, and resets the re-freezing counter of the re-freezing determination timer.

The above describes the specific embodiment of the present invention. However, the present invention is not limited to the above embodiment, but may be variously modified within scope of the technical ideas of the invention.

For example, internal combustion engine 2 may be a diesel engine. The exhaust particulate filter is not limited to GPF 5, but may be a Diesel Particulate Filter (DPF).

The above embodiment is directed to an exhaust system state determination method and an exhaust system state determination device for exhaust system 1.

1. An exhaust system state determination method for an exhaust system including an internal combustion engine mounted in a vehicle and a differential pressure sensor structured to measure a pressure loss at an exhaust particulate filter disposed in an exhaust passage of the internal combustion engine, the exhaust system state determination method comprising:
determining that freezing in one of the differential pressure sensor and a path structured to introduce pressure into the differential pressure sensor is present, in response to satisfaction of conditions that: the internal combustion engine has been temporarily stopped for a predetermined time period or longer, during driving of the vehicle; and an outside air temperature is equal to or lower than a predetermined temperature.

2. The exhaust system state determination method as claimed in claim 1, wherein:
the exhaust system includes a timer configured to measure a duration time period of the temporary stopping of the internal combustion engine; and
the duration time period is measured by the timer.

3. The exhaust system state determination method as claimed in claim 1, wherein the temporary stopping of the internal combustion engine is performed by idle stopping.

4. The exhaust system state determination method as claimed in claim 1, wherein:
the vehicle is structured to perform EV travel that is self-propelled travel with the internal combustion engine stopped; and
the temporary stopping of the internal combustion engine is performed during the EV travel.

5. The exhaust system state determination method as claimed in claim 1, wherein the predetermined time period is changed depending on the outside air temperature.

6. The exhaust system state determination method as claimed in claim 1, the method further comprising:
comparing a first deposit amount and a second deposit amount, wherein: the first deposit amount is calculated based on an output signal of the differential pressure sensor; and the second deposit amount is calculated based on operational status of the internal combustion engine;
determining a deposit amount of exhaust particles in the exhaust particulate filter to be a larger one of the first deposit amount and the second deposit amount; and
suspending the calculation of the first deposit amount and determining the deposit amount of exhaust particles in the exhaust particulate filter to be the second deposit amount, in response to satisfaction of a condition that the freezing in one of the differential pressure sensor and the path structured to introduce pressure into the differential pressure sensor is present.

7. An exhaust system state determination device for an internal combustion engine mounted in a vehicle, the exhaust system state determination device comprising:
an exhaust particulate filter disposed in an exhaust passage of the internal combustion engine;
a differential pressure sensor structured to measure a pressure loss at the exhaust particulate filter; and
a determination section configured to determine that freezing in one of the differential pressure sensor and a path structured to introduce pressure into the differential pressure sensor is present, in response to satisfaction of conditions that: the internal combustion engine has been temporarily stopped for a predetermined time period or longer, during driving of the vehicle; and
an outside air temperature is equal to or lower than a predetermined temperature.
